(19) United States
(12) Patent Application Publication
(10) Pub. No.: US 2020/0134646 A1
(43) Pub. Date: Apr. 30, 2020

(54) INFORMATION DELIVERY METHOD, INFORMATION DELIVERY APPARATUS, AND STORAGE MEDIUM STORING INFORMATION DELIVERY PROGRAM

(71) Applicants: TOYOTA JIDOSHA KABUSHIKI KAISHA, Toyota-shi (JP); JapanTaxi Co., Ltd., Chiyoda-ku (JP)

(72) Inventors: Daiki KANEICHI, Nissin-shi (JP); Yuichi Komatsu, Yokohama-shi (JP); Kiichi Ueta, Bunkyo-ku (JP)

(73) Assignees: TOYOTA JIDOSHA KABUSHIKI KAISHA, Toyota-shi (JP); JapanTaxi Co., Ltd., Chiyoda-ku (JP)

(21) Appl. No.: 16/666,606

(22) Filed: Oct. 29, 2019

(30) Foreign Application Priority Data
Oct. 31, 2018 (JP) 2018-205050

(51) Int. Cl. G06Q 30/02; G06Q 10/06; G08G 1/00; G06Q 50/30

(52) U.S. Cl. CPC G06Q 30/0202; G06Q 10/06315; G06Q 50/30; G08G 1/202; G06Q 10/0639

(57) ABSTRACT

An information delivery method includes: a step of acquiring information on taxi dispatching performance at a taxi stand by collecting, on a taxi stand dedicated to a taxi company, location information and status information of a subject taxi of the taxi company and acquiring, on a taxi stand other than the taxi stand dedicated to the taxi company, data of a surrounding image captured by an image capturing unit provided in the subject taxi of the taxi company, and predicting demand for a taxi dispatch after a discretionary time at the taxi stand simultaneously; and a step of delivering the information on the taxi dispatching performance and information on predicted demand for the taxi dispatch at the taxi stand.

### INCORPORATION BY REFERENCE

The disclosure of Japanese Patent Application No. 2018-205050 filed on Oct. 31, 2018 including the specification, drawings and abstract is incorporated herein by reference in its entirety.

### BACKGROUND

### 1. Technical Field

The present disclosure relates to an information delivery method, an information delivery apparatus, and a storage medium storing an information delivery program.

### 2. Description of Related Art

A technology for predicting demand for a taxi dispatch at a taxi stand based on information on the taxi stand, acquired by a taxi company from its subject taxi, is known.

### SUMMARY

So far, information on a taxi dispatch at a taxi stand has been generated based on information acquired by a taxi company from its subject taxi. For this reason, there have been biased information and a time lag in information updating, and thus it has been difficult for users to feel convenient.

The present disclosure provides an information delivery method, an information delivery apparatus, and a storage medium for storing an information delivery program, which can provide information on a taxi dispatch at a taxi stand in real time.

An information delivery method according to a first aspect of the present disclosure is executed by an information delivery apparatus. The information delivery method includes: a step of acquiring information on taxi dispatching performance at a taxi stand by collecting, on a taxi stand dedicated to a taxi company, location information and status information of a subject taxi of the taxi company and acquiring, on a taxi stand other than the taxi stand dedicated to the taxi company, data of a surrounding image captured by an image capturing unit provided in the subject taxi of the taxi company, and predicting demand for a taxi dispatch after a discretionary time at the taxi stand simultaneously; and a step of delivering the information on the taxi dispatching performance and information on predicted demand for the taxi dispatch at the taxi stand. The taxi stand includes the taxi stand dedicated to the taxi company and the taxi stand other than the taxi stand dedicated to the taxi company.

The information delivery apparatus may calculate the number of taxis waiting to pick up a passenger at the taxi stand based on the information on the taxi dispatching performance, and deliver information on the calculated number of taxis waiting to pick up a passenger at the taxi stand.

The information delivery apparatus may calculate a passenger turnover of taxis at the taxi stand based on a difference between the time at which each taxi arrives at the taxi stand and the time at which the taxi picks up a passenger at the taxi stand, and deliver information on the calculated passenger turnover at the taxi stand.

An information delivery apparatus according to a second aspect of the present disclosure includes a memory and a processor having hardware. The processor is configured to: acquire information on taxi dispatching performance at a taxi stand by collecting, on a taxi stand dedicated to a taxi company, location information and status information of a subject taxi of the taxi company and acquiring, on a taxi stand other than the taxi stand dedicated to the taxi company, data of a surrounding image captured by an image capturing unit provided in the subject taxi of the taxi company, and predict demand for a taxi dispatch after a discretionary time at the taxi stand simultaneously; and deliver the information on the taxi dispatching performance and the information on predicted demand for the taxi dispatch at the taxi stand. The taxi stand includes the taxi stand dedicated to the taxi company and the taxi stand other than the taxi stand dedicated to the taxi company.

A third aspect of the present disclosure relates to a storage medium storing an information delivery program that causes an information delivery apparatus to execute a process. The process includes: a step of acquiring information on taxi dispatching performance at a taxi stand by collecting, on a taxi stand dedicated to a taxi company, location information and status information of a subject taxi of the taxi company and acquiring, on a taxi stand other than the taxi stand dedicated to the taxi company, data of a surrounding image captured by an image capturing unit provided in the subject taxi of the taxi company, and predicting demand for a taxi dispatch after a discretionary time at the taxi stand simultaneously; and a step of delivering the information on the taxi dispatching performance and the information on predicted demand for the taxi dispatch at the taxi stand. The taxi stand includes the taxi stand dedicated to the taxi company and the taxi stand other than the taxi stand dedicated to the taxi company.

With an information delivery method, an information delivery apparatus, and a storage medium storing an information delivery program according to each aspect of the present disclosure, it is possible to provide information on a taxi dispatch at a taxi stand in real time.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a schematic diagram illustrating a configuration of a taxi dispatching system according to one embodiment;

FIG. 2 is a block diagram illustrating a configuration of a server illustrated in FIG. 1;

FIG. 3 is a block diagram illustrating a configuration of a taxi illustrated in FIG. 1; and

FIG. 4 is a flowchart illustrating a flow of an information delivery process according to one embodiment.

### DETAILED DESCRIPTION OF EMBODIMENTS

Hereinafter, a taxi dispatching system according to one embodiment will be described with reference to the drawings.

Configuration

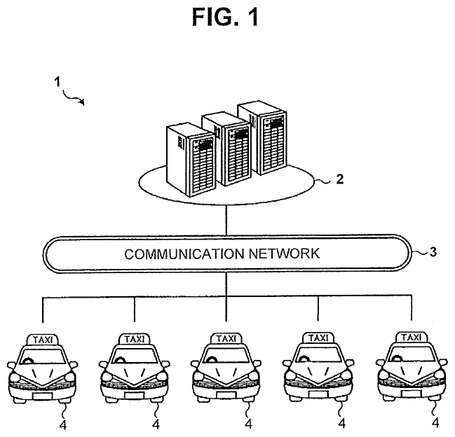

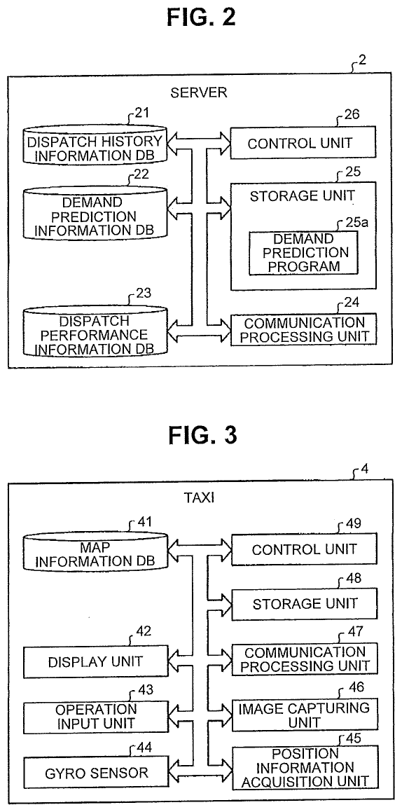

First, a configuration of the taxi dispatching system according to the embodiment will be described with reference to FIGS. 1 to 3. FIG. 1 is a schematic diagram illustrating the configuration of the taxi dispatching system according to the embodiment. FIG. 2 is a block diagram illustrating a configuration of a server 2, illustrated in FIG. 1. FIG. 3 is a block diagram illustrating a configuration of a taxi 4, illustrated in FIG. 1.

As illustrated in FIG. 1, the taxi dispatching system 1 according to the embodiment is an information processing system that enables a taxi to be dispatched efficiently by providing a taxi driver with information on predicting demand for a taxi dispatch (hereinafter, referred to as demand prediction information). The taxi dispatching system 1 includes, as main components, a server 2, and a plurality of taxis 4 connected to the server 2 via a communication network 3, such as an Internet network and a mobile phone network.

As illustrated in FIG. 2, the server 2 includes a taxi dispatch history information database (a taxi dispatch history information DB) 21, a demand prediction information database (a demand prediction information DB) 22, a taxi dispatching performance information database (a taxi dispatching performance information DB) 23, a communication processing unit 24, a storage unit 25, and a control unit 26. In addition, the server 2 may include a plurality of computers or may be a cloud server.

The taxi dispatch history information DB 21 stores taxi dispatch history information including information on a place at which a dispatch of the taxi 4 is requested (including information on a latitude and longitude, a mesh, and an administrative division (a block) such as a town name and an address), and information on the time at which the dispatch of the taxi 4 is requested.

The demand prediction information DB 22 stores the demand prediction information generated by the control unit 26 in a readable format via the communication network 3.

The taxi dispatching performance information DB 23 stores dispatching performance information of the taxi 4 at a taxi stand. Examples of the taxi dispatching performance information can include information such as an image at the taxi stand, the number of taxis 4 waiting to pick up a passenger at the taxi stand, and a passenger turnover of the taxis 4 at the taxi stand. The taxi dispatching performance information stored in the taxi dispatching performance information DB 23 is periodically updated by the server 2 that periodically communicates with the taxi 4 and acquires information therefrom.

The communication processing unit 24 includes a local area network (LAN) interface board, a wireless communication circuit for wireless communication, or the like. The communication processing unit 24 controls an information communication process with the taxi 4 via the communication network 3.

The storage unit 25 includes a recording medium fixed to a computer or the like, or a recording medium detachable from a computer or the like. Examples of the recording medium fixed to a computer or the like may include an erasable programmable ROM (EPROM) and a hard disk drive (HDD). Examples of the recording medium detachable from a computer or the like may include a universal serial bus (USB) memory, a flexible disk, an magneto-optical disk, a compact disc-read only memory (CD-ROM), a compact disc-rewritable (CD-RW), a digital versatile disc (DVD), a Blu-ray® disc (BD), a digital audio tape (DAT), an 8 mm-tape, and a memory card. A solid state drive (SSD) can be used as a recording medium detachable from a computer or the like, or as a recording medium fixed to a computer or the like.

The storage unit 25 stores an operating system, various computer programs, various tables, various databases, and the like. In the present embodiment, the storage unit 25 stores a demand prediction program 25a which is a computer program where a routine for generating the demand prediction information is described, and data including various setting information (not shown) for generating the demand prediction information. For provision, the demand prediction program 25a may be provided through downloading via the communication network 3.

The control unit 26 includes a processor including a central processing unit (CPU), a digital signal processor (DSP), and a field-programmable gate array (FPGA), and the like, and a memory (a primary storage unit) including a random access memory (RAM) and a read only memory (ROM), and the like (neither shown). The control unit 26 loads the computer programs stored in the storage unit 25 into a work area of the primary storage unit, and executes the loaded computer programs to control each component and the like, thereby executing a function that coincides with a predetermined purpose. In the present embodiment, the control unit 26 executes the demand prediction program 25a to generate the demand prediction information after a discretionary time, based on the taxi dispatch history information stored in the taxi dispatch history information DB 21. Alternatively, the control unit 26 may generate the demand prediction information after a discretionary time, based on information, other than the taxi dispatch history information, such as weather information, event information, and tenant information of the taxi stand.

As illustrated in FIG. 3, the taxi 4 includes a map information database (map information DB) 41, a display unit 42, an operation input unit 43, a gyro sensor 44, a location information acquisition unit 45, an image capturing unit 46, a communication processing unit 47, a storage unit 48, and a control unit 49.

The map information DB 41 stores map information. The map information includes information on a location and a shape of a road (for example, the number of lanes on the road, a lane type, such as a passing lane or a traveling lane), location information on an intersection and a junction, information on a river, a waterway, a railroad or the like, and information on an administrative division, such as a town name and an address. Alternatively, the taxi 4 may acquire necessary map information via the communication network 3 and use the acquired map information.

The display unit 42 includes a display device, such as a liquid crystal display device and an organic electro luminescence (EL) display device. The display unit 42 visually displays various kinds of information according to a display control signal from the control unit 49. Alternatively, the various kinds of information are visibly displayed in the present embodiment, but may be output in the form of audio.

The operation input unit 43 includes an operation input device, such as a keyboard, a touch panel, a switch, or a microphone. According to an operation of a driver of the taxi 4, the operation input unit 43 outputs, to the control unit 49, an operation input signal indicating the content of an operation.

The gyro sensor 44 acquires information on the direction in which the taxi 4 is heading, and outputs, to the control unit 49, a signal indicating the acquired direction in which the taxi 4 is heading.

The location information acquisition unit 45 receives a GPS signal from three or more global positioning system (GPS) satellites orbiting the Earth, and positions location information of the taxi 4 based on the received GPS signal. The location information acquisition unit 45 outputs, to the control unit 49, an electric signal indicating the positional location information of the taxi 4.

The image capturing unit 46 includes an image capturing device, such as a complementary MOS (CMOS) sensor and a charged coupled device (CCD) sensor. The image capturing unit 46 captures a surrounding image of its subject taxi, and stores, in the storage unit 48, data of the captured surrounding image. Alternatively, the image capturing unit 46 may directly transmit, to the server 2, the data of the captured surrounding image via the communication network 3.

The communication processing unit 47 includes a wireless communication circuit and the like for wireless communication. The communication processing unit 47 controls the information communication process with the server 2 via the communication network 3.

The storage unit 48 has a configuration similar to that of the storage unit 25 of the server 2. The storage unit 48 stores an operating system, various computer programs, various tables, various databases, and the like.

The control unit 49 has a configuration similar to that of the control unit 26 of the server 2. The control unit 49 loads the computer programs stored in the storage unit 48 into a work area of a primary storage unit, and executes the loaded computer programs to control each component and the like, thereby executing a function that coincides with a predetermined purpose.

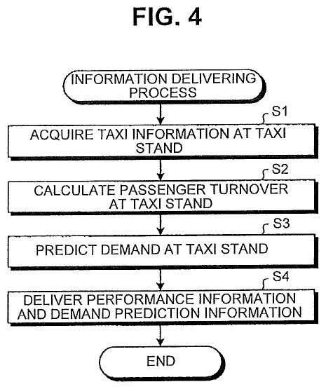

The taxi dispatching system 1 having a configuration as above enables the information on dispatching of the taxi 4 at a taxi stand to be provided to the driver of the taxi 4 in real time by executing an information delivery process to be described below. Hereinafter, with reference to FIG. 4, an operation of the taxi dispatching system 1 when the information delivery process is executed will be described.

Information Delivery Process

FIG. 4 is a flowchart illustrating a flow of the information delivery process according to the embodiment. In the flowchart illustrated in FIG. 4, the information delivery process starts when the server 2 is activated, and the information delivery process proceeds to a process of step S1. The information delivery process is repeatedly executed at every predetermined control cycle while the server 2 is being activated.

In the process of step S1, the control unit 26 of the server 2 acquires the dispatching performance information of the taxi 4 at the taxi stand via the communication network 3, and stores the acquired taxi dispatching performance information in the taxi dispatching performance information DB 23. Specifically, on a taxi stand dedicated to a taxi company, the control unit 26 acquires the location information and the status information (a taxi traveling empty, a taxi traveling to pick up a passenger, a taxi traveling while carrying a passenger) of the subject taxi 4 of the taxi company via the communication network 3, and based on the acquired information, calculates, as the taxi dispatching performance information, the number of the subject taxis 4 of the taxi company waiting to pick up a passenger. In addition, on a taxi stand other than the taxi stand dedicated to the taxi company, the control unit 26 acquires the data of the surrounding image captured by the image capturing unit 46 provided in the subject taxi 4 of the taxi company via the communication network 3, and calculates, as the taxi dispatching performance information, the number of taxis 4 waiting to pick up a passenger, including the taxis 4 of other taxi companies, by analyzing the acquired data of the surrounding image. Whether the subject taxi 4 of the taxi company is at the taxi stand other than the taxi stand dedicated to the taxi company can be determined based on the location information of the subject taxi 4 of the taxi company. Further, the control unit 26 acquires from each taxi stand, as the taxi dispatching performance information, the information on the time at which the taxi 4 arrives at the taxi stand and the time at which the taxi 4 picks up a passenger at the taxi stand, via the communication network 3. Information on the time at which the taxi 4 arrives at the taxi stand and the time at which the taxi 4 picks up a passenger at the taxi stand can be calculated by, for example, analyzing an image of the taxi 4 captured by an image capturing device provided at the taxi stand. As such, the process of step S1 is completed, and the information delivery process proceeds to a process of step S2.

In the process of step S2, the control unit 26 calculates the passenger turnover at each taxi stand, based on the information on the time at which the taxi 4 arrives at each taxi stand and the time at which the taxi 4 picks up a passenger at each taxi stand. The above information is acquired at the process of step S1. Moreover, the control unit 26 may calculate the number of taxis 4 other than the subject taxi of the taxi company at each taxi stand, based on the passenger turnover of the subject taxis 4 at each taxi stand. In addition, the control unit 26 may rank each taxi stand based on the passenger turnover, a unit cost performance, and the like, of each taxi stand. As such, the process of step S2 is completed, and the information delivery process proceeds to a process of step S3.

In the process of step S3, the control unit 26 predicts demand for the taxi dispatch at each taxi stand in a discretionary time range. Specifically, the control unit 26 reads, from the demand prediction information DB 22, the demand prediction information at each taxi stand in a discretionary time range. As such, the process of step S3 is completed, and the information delivery process proceeds to a process of step S4.

In the process of step S4, the control unit 26 delivers, to the taxi 4 via the communication network 3, the taxi dispatching performance information calculated in the process of step S2, and the demand prediction information at each taxi stand in a discretionary time range calculated in the process of step S3. The taxi dispatching performance information includes the information on the passenger turnover at each taxi stand, the information on the number of the taxis 4 of other taxi companies, or the information on the rank of each taxi stand. As such, the process of step S4 is completed, and a series of information delivery processes are completed.

As clarified from the above description, in the information delivery process according to the embodiment, the server 2 acquire the dispatching performance information of the taxi 4 at the taxi stand by collecting, on the taxi stand dedicated to the taxi company, the location information and the status information of the subject taxi of the taxi company and acquiring, on the taxi stand other than the taxi stand dedicated to the taxi company, the data of the surrounding image captured by the image capturing unit 46 provided in the subject taxi 4 of the taxi company, and predicts demand for the taxi dispatch after a discretionary time at the taxi stand simultaneously. The server 2 delivers the dispatching performance information of the taxi 4 and the information on demand prediction for the taxi dispatch at the taxi stand. Therefore, it is possible to provide the information on the taxi dispatch at the taxi stand in real time.

As described above, although the embodiment was described, further effects or modifications can be easily derived by those skilled in the art. A broader aspect of the present disclosure is not limited to specific details and representative embodiments as described and shown above. Accordingly, various modifications may be made without departing from the scope of a general inventive concept as defined by appended claims and their equivalents.

What is claimed is:

1. An information delivery method executed by an information delivery apparatus, the method comprising:
acquiring information on taxi dispatching performance at a taxi stand by collecting, on a taxi stand dedicated to a taxi company, location information and status information of a subject taxi of the taxi company and acquiring, on a taxi stand other than the taxi stand dedicated to the taxi company, data of a surrounding image captured by an image capturing unit provided in the subject taxi of the taxi company, and predicting demand for a taxi dispatch after a discretionary time at the taxi stand simultaneously, the taxi stand including the taxi stand dedicated to the taxi company and the taxi stand other than the taxi stand dedicated to the taxi company; and
delivering the information on the taxi dispatching performance and information on the predicted demand for the taxi dispatch at the taxi stand.

2. The information delivery method according to claim 1, wherein the information delivery apparatus is configured to:
calculate the number of taxis waiting to pick up a passenger at the taxi stand based on the information on the taxi dispatching performance; and
deliver information on the calculated number of taxis waiting to pick up the passenger at the taxi stand.

3. The information delivery method according to claim 1, wherein the information delivery apparatus is configured to:
calculate a passenger turnover of taxis at the taxi stand based on a difference between a time at which each taxi of the taxis arrives at the taxi stand and a time at which the taxi picks up a passenger at the taxi stand; and
deliver information on the calculated passenger turnover at the taxi stand.

4. An information delivery apparatus comprising:
a memory; and
a processor including hardware,
wherein the processor is configured to:
acquire information on taxi dispatching performance at a taxi stand by collecting, on a taxi stand dedicated to a taxi company, location information and status information of a subject taxi of the taxi company and acquiring, on a taxi stand other than the taxi stand dedicated to the taxi company, data of a surrounding image captured by an image capturing unit provided in the subject taxi of the taxi company, and predict demand for a taxi dispatch after a discretionary time at the taxi stand simultaneously, the taxi stand including the taxi stand dedicated to the taxi company and the taxi stand other than the taxi stand dedicated to the taxi company; and
deliver the information on the taxi dispatching performance and information on the predicted demand for the taxi dispatch at the taxi stand.

5. A storage medium storing an information delivery program that causes an information delivery apparatus to execute a process, the process comprising:
acquiring information on taxi dispatching performance at a taxi stand by collecting, on a taxi stand dedicated to a taxi company, location information and status information of a subject taxi of the taxi company and acquiring, on a taxi stand other than the taxi stand dedicated to the taxi company, data of a surrounding image captured by an image capturing unit provided in the subject taxi of the taxi company, and predicting demand for a taxi dispatch after a discretionary time at the taxi stand simultaneously, the taxi stand including the taxi stand dedicated to the taxi company and the taxi stand other than the taxi stand dedicated to the taxi company; and
delivering the information on the taxi dispatching performance and information on predicted demand for the taxi dispatch at the taxi stand.
